(19) United States
(12) Patent Application Publication
(10) Pub. No.: US 2010/0015390 A1
(43) Pub. Date: Jan. 21, 2010

(54) WOOD COMPOSITE MATERIAL CONTAINING BALSAM FIR

(75) Inventors: Jianhua PU, Bishop, GA (US); Eric N. LAWSON, Grosse Ile, MI (US)

Correspondence Address: Gardner Groff Greenwald & Villanueva, PC, 2018 Powers Ferry Road, Suite 800, Atlanta, GA, 30339, US

(73) Assignee: HUBER ENGINEERED WOODS LLC, Charlotte, NC (US)

(21) Appl. No.: 12/502,107

(22) Filed: Jul. 13, 2009

Related U.S. Application Data
(63) Continuation-in-part of application No. 11/457,852, filed on Jul. 17, 2006, now Pat. No. 7,560,169.

(51) Int. Cl. B32B 21/00; B32B 21/14; B32B 27/04

(52) U.S. Cl. 428/106; 428/537.1; 428/292.4

(57) ABSTRACT

A wood composite board comprising balsam fir strands is disclosed.

### CROSS REFERENCE TO RELATED APPLICATION

This application is a continuation-in-part of pending U.S. patent application Ser. No. 11/457,852, which was filed on Jul. 17, 2006 and is entitled “WOOD COMPOSITE MATERIAL CONTAINING BALSAM FIR.” The disclosure of application Ser. No. 11/457,852 is hereby incorporated by reference in its entirety for all purposes.

### BACKGROUND OF THE INVENTION

Wood is a common material used in residential, commercial, and industrial constructions as structural panels, cabinet components, and door components as well as other functions. Even today, after the development of several new types of composite materials, wood remains one of the most widely-used structural materials because of its excellent strength and stiffness, pleasing aesthetics, good insulation properties and easy workability.

However, in recent years the cost of solid timber wood has increased dramatically as its supply shrinks due to the gradual depletion of old-growth and virgin forests. It is particularly expensive to manufacture doors from such material because typically less than half of the harvested logs is converted to solid sawn lumber, the remainder being discarded as scrap.

Accordingly, because of both the cost of high-grade solid wood as well as a heightened emphasis on conserving natural resources, wood-based alternatives to natural solid wood lumber have been developed that make more efficient use of harvested wood and reduce the amount of wood discarded as scrap. Plywood, particle board and oriented strand board (“OSB”) are examples of wood-based composite alternatives to natural solid wood lumber that have replaced natural solid wood lumber in many structural applications in the last seventy-five years.

While these wood-based composites use wood more efficiently, they have the disadvantage of not always being able to make full use of the available wood supply in the wood baskets adjacent to wood composite manufacturing plants. For example, when the wood supply includes material from multiple wood species, attempts to use the multiple wood species can cause problems, particularly an undesirable variation in product properties such as stiffness and strength, due to the inherent characteristics of the wood species. For instance, if two or more species are used that have different characteristics in their anatomical, physical, and mechanical attributes, it will add difficulties in the manufacturing process and in the end it will possibly undermine the quality of the product made.

Given the foregoing, there is a need in the art for wood composite materials made from wood species that are commonly available in known wood baskets which may be blended together to form wood composite materials having performance characteristics suitable for a wide range of uses.

### BRIEF SUMMARY OF THE INVENTION

The present invention includes a wood composite board comprising balsam fir (Abies balsamea) strands. The wood composite preferably contains about 1 wt % to about 99 wt % of the balsam fir strands.

### DETAILED DESCRIPTION OF THE INVENTION

All parts, percentages and ratios used herein are expressed by weight unless otherwise specified. All documents cited herein are incorporated by reference.

As used herein, “wood” is intended to mean a cellular structure, having cell walls composed of cellulose and hemicellulose fibers bonded together by lignin polymer. It should further be noted that the term “wood” encompasses lignocellulosic material generally.

By “wood composite material” it is meant a composite material that comprises one or more wood species and one or more wood composite additives, such as adhesives or waxes. The wood is typically in the form of veneers, flakes, strands, wafers, particles, and chips. Non-limiting examples of wood composite materials include oriented strand board (“OSB”), waferboard, particle board, chipboard, medium-density fiberboard, plywood, parallel strand lumber, oriented strand lumber, and laminated strand lumbers. Common characteristics of wood composite materials are that they are composite materials comprised of strands and ply veneers bonded with polymeric resin and other special additives. As used herein, “flakes”, “strands”, “chips”, “particles”, and “wafers” are considered equivalent to one another and are used interchangeably. A non-exclusive description of wood composite materials may be found in the Supplement Volume to the Kirk-Othmer Encyclopedia of Chemical Technology, pp 765-810, 6^{th} Edition.

The present invention includes wood composite lumber, boards, and panels comprising balsam fir strands embodiments. Such boards and panels include 4′×8′ panels used in constructing a building structure, although panels of other dimensions are within the scope of the present invention. The composite panels discussed herein are generally rectangular planes (or substantially planar), having two sets of substantially parallel edges. The panels according to the present invention vary in thickness from about 0.25 inches thick to about 4.0 inches thick, although each individual panel is of substantially uniform thickness. In addition, although each panel is formed from numerous strips/flakes of balsam fir and other wood species, each completed panel is a single unitary component (such as an OSB panel, etc.). Specific commercial embodiments of panels according to the present invention have panel dimensions of 4 feet by 8 feet (plus or minus about 1 inch to account for margin of error in manufacturing, wherein a commercial panel having panel dimensions of 4 feet by 8 feet can in actuality extend from 3 feet 11 inches to 4 feet 1 inch by 7 feet 11 inches to 8 feet 1 inch). Other commercial embodiments of the present invention yield panels having dimensions of about 4 feet by about 10 feet, about 4 feet by about 16 feet, and about 8 feet by about 16 feet. The thinnest panels formed according to example embodiments disclosed herein could be used, e.g., as web stock for engineered wood I-joists. The panels of intermediate thickness could be used as sheathing and sub flooring. The thicker panels could be used for millwork and lumber applications. Another use for the panels formed according to example embodiments disclosed herein could be as shipping containers and decking material for transportation trailers.

By “balsam fir strands” it is meant strands made from trees of the species Abies balsamea commonly known as “balsam fir”. Abies balsamea is a northern growing species of tree found in the Northeastern United States in states such as Maine, Vermont, New Hampshire, and New York. It can also be found in parts of the upper Midwest including Michigan, Wisconsin, and Minnesota, although the greatest extent of its range is central to eastern Canada. While the wood is widely used among model makers and hobbyists, and apparently makes good paper, it is of marginal use as a lumber material because of its low density, which typically is indicative of poor physical properties such as strength, stiffness, and nail withdrawal strength. Because of this, even though the trees are widely available in its native habitat, the lumber is typically only used in light construction.

Nail withdrawal strength refers to the ability of a material to “hold” a nail when a pullout force is exerted on the nail. For a material to be used in building structures especially in residential, commercial, and industrial applications, the importance of good nail withdrawal strength cannot be overstated. When a wood composite board is used for roof or wall sheathing, it is critical that the wood composite have sufficient nail withdrawal strength so that roofing paper, shingles, and house wrap affixed to the wood composite board with nails or similar fasteners will stay attached to the board. Loose nails may allow a panel to become loosened from rafters during high winds, possibly exposing the interior of a building to outside weather conditions. In particularly severe cases, such as hurricanes or very high speed winds, detaching of the panel from the rafters adds to the lift force already being experienced by the panel and may potentially cause the complete removal of the panel possibly resulting in the total destruction of the house or, at the very least, transforming the panel into a highly dangerous projectile that could potentially cause serious injury and/or property damage.

Although less serious in terms of physical safety (but more typical in terms of homeowner satisfaction), nail withdrawal strength is also important when attaching a subfloor panel into the joists underneath and for nailing a finishing floor (such as hardwood flooring) to the subfloor panel. Poor nail withdrawal strength will result in loose nails, which cause squeaks and popping sounds in floors as a person walks across the surface—for example, if the nail has risen from the surface of the panel, the panel will slide up and down the nail, causing the typical and detested squeaking sounds.

Given the poor nail withdrawal strength of Abies balsamea, one would consequently also expect that wood composite board made with the balsam fir material would have a low nail holding capacity as well, in addition to low bending stiffness and strength. There are yet other potential complications resulting from the use of balsam fir in the manufacture of wood composite boards. For example, balsam fir may have a higher concentration of wood extractives resulting in higher dryer emissions as compared to Aspen and other hardwood species. Moreover, the drying characteristics of balsam fir strands may differ from those of the currently used species, and, thus, may present challenges for consistent moisture control in the combined furnishes. Poor strand geometry and higher fines generation could also result when incorporating balsam fir into an existing wood mix if proper process adjustments are not in place. Finally, it is important to take the appropriate steps to obtain a quality appearance of finished products in spite of possible discoloration caused by the use of a species such as balsam fir.

Boards or panels prepared according to the present invention can be made in the form of a variety of different materials, such as wood or wood composite materials, such as oriented strand board (“OSB”). In addition to balsam fir, OSB panels can also incorporate strands from other wood species materials, including naturally occurring hardwood or softwood species, singularly or mixed, whether such wood is dry (having a moisture content of between 2 wt % and 12 wt %) or green (having a moisture content of between 30 wt % and 200 wt %). Suitable other wood species, in addition to balsam fir, include pine species such as Loblolly pine, Virginia Pine, slash pine, short leaf pine, and long leaf pines, as well as Aspen or other hardwood species similar to Aspen. Wood boards of the present invention can include about 1 wt % to about 99 wt % balsam fir wood and about 99 wt % to about 1 wt % of other wood species.

Typically, raw wood starting materials, either virgin or reclaimed, are cut into strands, wafers or flakes of desired size and shape, which are well known to one of ordinary skill in the art. The strands are preferably more than 2 inches long, more than 0.3 inch wide, and less than 0.25 inch thick. While not intended to be limited by theory, it is believed that longer strands, i.e., longer than about 6 inches, improves the final product mechanical strength by permitting better alignment. It is also known that uniform-width strands are preferred for better product quality. Uniform strand geometry allows a manufacturer to optimize the manufacturer's process for a particular strand size selected. For instance, if all the strands were 4 inches×1 inch, then the orienter could be optimized to align those strands within a single layer. If strands that were 1 inch long and 0.25 inch wide were added, some of those could slide thru the orienters sideways. Cross-oriented strands lower the overall mechanical strength/stiffness of a product.

After the strands are cut, they are dried in a dryer to a moisture content of about 1 to 20%, preferably between 2 to 18%, more preferably from 3 to about 15%, and then coated with one or more polymeric thermosetting binder resins, waxes and other additives. The binder resin and the other various additives that are applied to the wood materials are referred to herein as a coating, even though the binder and additives may be in the form of small particles, such as atomized particles or solid particles, which do not form a continuous coating upon the wood material. Conventionally, binder, wax and any other additives are applied to the wood materials by one or more spraying, blending or mixing techniques. A preferred technique is to spray the wax, resin and other additives upon the wood strands as the strands are tumbled in a drum blender.

After being coated and treated with the desired coating and treatment chemicals, these coated strands are used to form a multi-layered mat. In a conventional process for forming a multi-layered mat, the coated wood materials are spread on a conveyor belt in a series of two or more, preferably three layers. The strands are positioned on the conveyor belt as alternating layers where the “strands” in adjacent layers are oriented generally perpendicular to each other. It is understood by those skilled in the art that the products made by this process could have the strands aligned all in the same direction or randomly without a particular alignment.

Preferably, when another wood species is used in addition to balsam fir strands, the balsam fir strands and the strands of the other wood species are blended together such that the wood strands of all species are intermixed throughout the layers of the entire panel. In other words, each layer of the panel includes a mixture of wood species. In an alternative embodiment, the panel can include alternating layers of balsam fir strands and other wood species strands. For example, in a three layer panel, the outer layers can be formed of balsam fir strands while the core layer is formed of strands of another wood species, or vice versa.

Various polymeric resins, preferably thermosetting resins, may be employed as binders for the wood flakes or strands. Suitable polymeric binders include isocyanate resin, urea-formaldehyde, phenol formaldehyde, melamine formaldehyde (“MUF”) and the co-polymers thereof. Isocyanates are the preferred binders, and preferably the isocyanates are selected from the diphenylmethane-p,p′-diisocyanate group of polymers, which have NCO— functional groups that can react with other organic groups to form polymer groups such as polyurea, —NCON—, and polyurethane, —NCOO—. 4,4-diphenyl-methane diisocyanate (“MDI”) is preferred. A suitable commercial pMDI product is RUBINATE® 1840 available from Huntsman, Salt Lake City, Utah, and MONDUR® 541 pMDI available from Bayer Corporation, North America, of Pittsburgh, Pa. Suitable commercial MUF binders are the LS 2358 and LS 2250 products from Dynea Corporation, Helsinki, Finland.

The binder concentration is preferably in the range of about 1.5 wt % to about 20 wt %, more preferably about 2 wt % to about 10 wt %. A wax additive is commonly employed to enhance the resistance of the OSB panels to moisture penetration. Preferred waxes are slack wax or an emulsion wax. The wax loading level is preferably in the range of about 0.5 to about 2.5 wt %.

The invention will now be described in more detail with respect to the following, specific, non-limiting examples.

### EXAMPLES

Wood composite boards were prepared according to the present invention and according to the prior art in order to demonstrate the superior wood performance characteristics of wood boards prepared according to the present invention. Aspen logs and balsam fir logs were obtained for use. The logs were cut into strands, the strands dried, and the strands pressed into panels having varied concentrations of aspen and balsam fir strands as set forth in Table I, below. The strands of the two species were intermixed completely with each other so that the mixture occurred uniformly throughout the panel. The panels included surface and core layers, wherein the strands in the surface and core layers were oriented 90° with respect to each other. The strands themselves were between 1 to 6 inches in length, 0.25 to 4 inches wide and 0.005 to 0.150 inch thick. The panels contained 5 wt % pMDI resin. The pMDI resin was RUBINATE® 1840 pMDI available from Huntsman Corporation, Salt Lake City, Utah. The panels also contained 1.5 wt % slack wax.

The panels were cut into smaller sizes, and the density and nail withdrawal strength were measured according to the protocol specified in ASTM D1037-99 (see Nail Withdrawal Test, Paragraphs 47-53). The results are set forth in Table I, below.

TABLE I

| | | | | | Nail | Nail |
|---|---|---|---|---|---|---|
| | | | | | Withdrawal | Withdrawal |
| % Balsam | % | Thickness | Density | Load | per inch thick | per inch thick |
| Fir¹ | Aspen¹ | (in) | (pcf) | (lb) | (lbs/in) | (lbs/in)² |
| 0 | 100 | 0.765 | 40.0 | 112 | 146 | 142 |
| 25 | 75 | 0.759 | 39.5 | 115 | 152 | 149 |
| 50 | 50 | 0.764 | 40.8 | 129 | 168 | 161 |
| 75 | 25 | 0.756 | 39.4 | 125 | 166 | 164 |
| 100 | 0 | 0.768 | 40.4 | 141 | 184 | 178 |

¹Based on total weight of the board
²Normalized to 39 pcf of density

As can be seen in Table I, the OSB board prepared according to the present invention (those having a balsam fir content of from about 25% to about 100%) actually had superior nail withdrawal strength than the samples prepared according to the prior art (the board with a balsam fir content of 0%). Thus, increasing the balsam fir content actually increased the nail withdrawal strength. Such a result is surprising and unexpected to a person of ordinary skill in the art.

Additionally, there was no degradation of bending MOR (strength) or MOE (stiffness) in the panels comprising balsam fir strands (data not shown). In other words, the panels that included balsam fir strands performed as well as those comprising only Aspen strands. Moreover, mixing the balsam fir strands and the Aspen strands had no significant effect on bending (data not shown).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A multi-layered wood composite board, comprising:
a plurality of layers of wood strands, wherein the wood strands of each layer include about 25 wt % to about 75 wt % of balsam fir strands and about 25 wt % to about 75 wt % of wood strands of at least one wood species other than balsam fir, wherein the balsam fir strands increase nail withdrawal strength of the board relative to a board without balsam fir strands, and wherein the wood strands are bound together with a polymeric binder.

2. The wood composite board according to claim 1, wherein the wood composite board has a density of about 15 lbs/ft³ to about 50 lbs/ft³.

3. The wood composite board according to claim 1, wherein the wood composite board is in the form of an oriented strand board.

4. The wood composite board according to claim 1, wherein the wood composite board comprises from about 1 wt % to about 20 wt % of the polymeric binder.

5. The wood composite board according to claim 1, wherein a nail withdrawal strength according to ASTM D1037 of the board is at least about 149 lbf for an about 39 pcf density board.

6. The wood composite board according to claim 1, wherein the at least one wood species is selected from the group consisting of aspen and pine.

7. The wood composite board according to claim 1, wherein the wood strands have substantially uniform sizes.

8. The wood composite board according to claim 7, wherein the wood strands generally all have lengths of about 1 to about 6 inches, widths of about 0.25 to about 4 inches, and thicknesses of about 0.005 to 0.150 inches.

9. The wood composite board according to claim 1, wherein the increased nail withdrawal strength is at least about 5% greater than the nail withdrawal strength of a board without balsam fir strands.

10. A wood composite board, comprising:
about 25 wt % to about 99 wt % of balsam fir strands;
about 1% wt % to about 75 wt % of strands of at least one wood species other than balsam fir; and
about 1 wt % to about 20 wt % of polymeric binder,
wherein the wood composite board has a density of about 15 lbs/ft³ to about 50 lbs/ft³.

11. The wood composite board of claim 10, wherein the strands of at least one wood species other than balsam fir comprise aspen strands.

12. The wood composite board of claim 10, wherein the strands of at least one wood species other than balsam fir comprise pine strands.

13. The wood composite board according to claim 10, wherein the balsam fir strands generally all have lengths of about 1 to about 6 inches, widths of about 0.25 to about 4 inches, and thicknesses of about 0.005 to 0.150 inches.

14. A method for increasing nail withdrawal strength of a composite board comprising wood strands, the steps comprising:
adding an amount of balsam fir strands effective to increase nail withdrawal strength of the board relative to a board without balsam fir strands.
